(19) United States
(12) Patent Application Publication
(10) Pub. No.: US 2018/0114120 A1
(43) Pub. Date: Apr. 26, 2018

(54) COGNITIVE INCIDENT ANALYSIS AND PREDICTIVE NOTIFICATION

(71) Applicant: International Business Machines Corporation, Armonk, NY (US)

(72) Inventors: James E. Bostick, Cedar Park, TX (US); John M. Ganci, JR., Cary, NC (US); Martin G. Keen, Cary, NC (US); Sarbajit K. Rakshit, Kolkata, IN (US)

(73) Assignee: International Business Machines Corporation, Armonk, NY (US)

(21) Appl. No.: 15/333,628

(22) Filed: Oct. 25, 2016

(51) Int. Cl. G06N 5/02

(52) U.S. Cl. CPC G06N 5/022

(57) ABSTRACT

A data item in a dataset related to a past event is analyzed to identify an anomaly in the data item. A set of data characteristics is determined in the dataset, the set of data characteristics forming a root cause of an undesirable outcome related to the past event. An incident insight logic is constructed using the set of data characteristics. An evaluation is made that a second dataset related to a future event satisfies the incident insight logic. In response to the evaluating, a confidence value is computed of a predicted undesirable outcome related to the future event. A corrective action that has been configured to avoid an occurrence of the predicted undesirable outcome is selected.

### TECHNICAL FIELD

The present invention relates generally to a method, system, and computer program product for detecting undesirable situations experienced by users in day to day life. More particularly, the present invention relates to a method, system, and computer program product for cognitive incident analysis and predictive notification.

### BACKGROUND

People experience disappointments, missed opportunities, unpreparedness, discouragement, unfortunate occurrences, and generally undesirable situations in everyday life. For example, a person might arrive at a concert having forgotten the ticket at home, or with only an electronic ticket on a mobile device where a printed ticket is required. As another example, a person might visit an establishment and forget to collect their credit card back from the merchant or may lose their wallet during the visit. As another example, a person visiting experience a theft from their vehicle while visiting a location. As another example, a person might stay up too late and as a result be ill-prepared for an early morning meeting.

Hereinafter, an undesirable situation or experience of these and other kinds is interchangeably referred to as an “incident” unless expressly disambiguated where used. In most instances incidents are repeatable—either occurring repeatedly with an individual (e.g., “I'm always forgetting to pick up my car keys when I stay at a hotel”), to another person, or to a group (e.g., 100 people forgot to print out their tickets for an event and electronic tickets are not accepted).

### SUMMARY

The illustrative embodiments provide a method, system, and computer program product. An embodiment includes a method that analyzes, using a processor and a memory, a data item in a dataset related to a past event, to identify an anomaly in the data item. The embodiment determines a set of data characteristics in the dataset, the set of data characteristics forming a root cause of an undesirable outcome related to the past event. The embodiment constructs an incident insight logic using the set of data characteristics. The embodiment evaluates, using the processor and the memory, that a second dataset related to a future event satisfies the incident insight logic. The embodiment computes, responsive to the evaluating, a confidence value of a predicted undesirable outcome related to the future event. The embodiment selects a corrective action that has been configured to avoid an occurrence of the predicted undesirable outcome.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for cognitive incident analysis and predictive notification in accordance with an illustrative embodiment;

FIG. 4 depicts a block diagram of another configuration for cognitive incident analysis and predictive notification in accordance with an illustrative embodiment;

FIG. 5 depicts a flowchart of an example process for cognitive incident analysis and predictive notification in accordance with an illustrative embodiment; and

FIG. 6 depicts a flowchart of another example process for cognitive incident analysis and predictive notification in accordance with an illustrative embodiment.

### DETAILED DESCRIPTION

The illustrative embodiments recognize that users experiencing incidents typically do not do so in silence. There are records of these incidents occurring, e.g., text messages sent to friends, postings on social media, pictorial evidence, and so forth.

The illustrative embodiments recognize that by understanding when and how an incident occurred with a user in the past, the illustrative embodiments can determine the root cause behind the incident, and take a corrective action to help prevent the incident from occurring again in the future. Furthermore, through continual monitoring and analysis the illustrative embodiments can predict when a user is likely to encounter an incident and notify that user about the imminent incident, a corrective action to prevent the incident, or both.

For example, if a user often forgets, or has previously forgotten, to print their event ticket, an embodiment can remind the user ahead of a time of a future similar event to print the ticket before proceeding to the event. As another example, if the user has a habit of staying up too late before early meetings and then regretting that action the next morning, an embodiment can detect an upcoming early morning meeting the night before, and notify the user that staying up late is not advised.

The illustrative embodiments recognize that the presently available tools or solutions do not address these needs or provide adequate solutions for these needs. The illustrative embodiments used to describe the invention generally address and solve the above-described problems and other problems related to cognitive incident analysis and predictive notification.

An embodiment can be implemented as a software application. The application implementing an embodiment can be configured as a modification of an existing data analysis system, as a separate application that operates in conjunction with an existing data analysis system, a standalone application, or some combination thereof.

One embodiment collects a set of data from a variety of sources, including but not limited to an application operating in a device (client) used by a user, a service executing elsewhere (e.g., in a cloud environment), a repository of data, and the like. For example, a client application (referred to herein as a “client app”) may provide data containing text messages sent and/or received by the user, pictures taken by the user, email messages sent and/or received by the user, voice data recorded by the user, a biometric data of the user, a location of the user at a given time, and the like. A data source in a cloud may provide data posted by the user on a social media network, website and/or link browsed by the user from a location, data from a calendar maintained by the user, and the like.

These examples of data sources and the types of data are not intended to be limiting. From this disclosure, those of ordinary skill in the art will be able to conceive many other data sources and the types of data and the same are contemplated within the scope of the illustrative embodiments.

The embodiment is configured to recognize certain anomalies in the data as indicators of an incident. For example, if a natural language processing (NLP) of a text message reveals a meaning similar to losing something, forgetting something, suffering an undesirable occurrence, displeasure, upset or unfavorable sentiment, and the like, the embodiment is configured to recognize such a text message as an indicator of an incident. An email message and text in other types of data in the dataset can be similarly parsed and correlated with incidents.

As another example, if image analysis of a picture or video reveals a meaning similar to losing something, forgetting something, suffering an undesirable occurrence, displeasure, upset or unfavorable sentiment, and the like, the embodiment is configured to recognize such image data as an indicator of an incident. As another example, if voice or speech analysis of an audio recording reveals a meaning similar to losing something, forgetting something, suffering an undesirable occurrence, displeasure, upset or unfavorable sentiment, and the like, the embodiment is configured to recognize such audio data as an indicator of an incident.

In a given dataset, an anomaly indicative of an incident may be present in a single data item or multiple data items. When anomalies are present in multiple data items, the embodiment correlates the anomalies and the data items with each other to identify the incident.

An embodiment further uses the one or more correlated anomalies to identify a root cause for the incident. For example, the user texted “cannot get it without a printed ticket, can you print mine?” to a friend, in an incident involving denial of admission to an event because of the root cause that the user purchased an electronic ticket to an event, scheduled arriving at the event, and failed to print an electronic ticket before arriving at the event.

The purchasing of an electronic ticket is a characteristic of the data in the dataset that includes the incident. In other words, the root cause includes one or more characteristics of data that in combination have the potential to cause the incident. Root cause analysis of different correlated anomalies in different datasets can lead to different combinations of data characteristics in different root causes of different incidents.

Once the anomalies have been correlated in a given dataset, and a root cause for the corresponding incident has been determined as described herein, an embodiment constructs an incident insight logic corresponding to the incident. An incident insight logic is logic that is configured to determine whether one or more data characteristics that form the root cause of an of a corresponding incident are present in a given dataset. The incident insight logic produces a likelihood of the incident given the dataset, a corrective action, a suggestion for a corrective action, or some combination thereof.

For example, suppose that a dataset related to an event in a past period has anomalies that correspond to an example “denied admission due to no printed ticket” incident. The root cause of that incident includes data characteristics indicating that the user purchased an electronic ticket to an event, scheduled arriving at the event, and failed to print an electronic ticket before arriving at the event. Accordingly, an incident insight logic constructed from the past incident is configured to determine whether a future dataset include data characteristics indicative of the user purchasing an electronic ticket to a future event, scheduling to arriving at the event, printing (or not printing) the ticket, or some combination thereof. In other words, given a dataset corresponding to a future event, an incident insight logic determines whether the root cause corresponding to the incident insight logic is present in the dataset of the future event at least to a threshold degree.

For example, according to the dataset of the future event, the user may have only bought the electronic ticket but may not have scheduled to go to the event, and there may be no indication whether the ticket has been printed. Simply buying the electronic ticket may be a sufficient degree of match between the root cause of the incident insight logic and the dataset of the future event. Accordingly, the incident insight logic may trigger a likelihood of the incident occurring at the future event, a corrective action of automatically printing the electronic ticket, a suggestion for a corrective action—i.e. to print the electronic ticket, or some combination thereof.

As another example, according to the dataset of the future event, the user may have bought the electronic ticket and may have scheduled to go to the event, but there may be no indication whether the ticket has been printed. Buying the electronic ticket and scheduling to go to the event may be a sufficient degree of match between the root cause of the incident insight logic and the dataset of the future event. Accordingly, the incident insight logic may trigger a likelihood of the incident occurring at the future event, a corrective action of automatically printing the electronic ticket, a suggestion for a corrective action—i.e. to print the electronic ticket, or some combination thereof.

Once an incident insight logic is constructed, an embodiment saves the incident insight logic for use with the user's future datasets. The embodiment also saves an incident log in an incident log repository. For example, an incident log entry can include, but is not limited to the type of event related to the dataset, data anomalies and their types, root cause and its characteristics, correlations between the anomalies and the characteristics, location of the incident, data used in the detection of the incident, and the like. The incident logs can also serve as input to an embodiment in determining whether a given dataset has anomalies, rot cause characteristics, or other indicators to create new incident insight logic or modify an existing incident insight logic.

An embodiment further removes identifying information from the incident insight logic that can be used to identify the user and constructs a normalized or anonymized incident insight logic. An anonymized incident insight logic can be used with future datasets of other users. For example, a user who has never been denied entry to an event in the past for lacking a printed ticket can nevertheless be cautioned to print an electronic ticket because some other user has had that incident occur in the past.

Once a repository of individual incident insight logic, anonymized incident insight logic, or some combination thereof is available, datasets relating to future events can be analyzed. For example, one embodiment receives a dataset corresponding to a future event. The embodiment determines whether the dataset includes at least a threshold degree of match with a root cause of an incident insight logic in the repository, to wit, whether the dataset includes at least a threshold amount of data characteristics related to a root cause of an incident insight logic, such that a likelihood of a future incident exists, and/or a corrective action should be triggered or advised.

An embodiment computes a confidence value for the determination that the likelihood of future incident exists, and/or a corrective action should be taken or advised. For example, if the characteristics of the data in the dataset of the future event matches up to a first threshold degree, the confidence value may be below a first confidence threshold; if the characteristics of the data in the dataset of the future event matches up to a second threshold degree, the confidence value may be above the first confidence threshold but below a second confidence threshold; and so on. The confidence value may also be configured to depend on the quality of the match. For example, if a characteristic in the data in the dataset of the future event is a match within a first tolerance value to a characteristic in a root cause, the confidence value may be below one threshold; if a characteristic in the data in the dataset of the future event is an exact match to a characteristic in a root cause, the confidence value may exceed that threshold; and so on.

These examples of manners of computing confidence values are not intended to be limiting. From this disclosure, those of ordinary skill in the art will be able to conceive many other manners of computing confidence values and the same are contemplated within the scope of the illustrative embodiments.

An embodiment adjusts the confidence based on user preferences. For example, in some cases, an incident may be likely but the incident may not be applicable to the user. For example, if the incident is “purse snatching at a location” but the user does not carry a purse, the incident, however likely, may not be applicable to the user. If an incident is not applicable to the user according to a user preference, or the user has set a preference that makes notifications about certain types of incidents less useful to the user, the embodiment decreases the confidence in those predicted incidents. Conversely, if the user has set a preference that makes notifications about certain types of incidents more useful to the user, the embodiment increases the confidence in those predicted incidents.

These examples of preference-based confidence adjustment are not intended to be limiting. From this disclosure, those of ordinary skill in the art will be able to conceive many other preferences and corresponding confidence value adjustments, and the same are contemplated within the scope of the illustrative embodiments.

When a predicted incident, i.e., an incident that has a likelihood of occurring, receives a confidence value exceeding a notification threshold, an embodiment constructs a notification for the user. The notification advises the user of the likelihood of the incident and of a corrective action that can be taken to prevent the incident from occurring. The corrective actions can be programmed for a root cause into an incident insight logic, or can be machine-learned from datasets where the incident was also resolved using a corrective action by the user.

An embodiment can be configured to automatically take or perform a corrective action, e.g., print an electronic ticket automatically. An embodiment can be configured to delay the notification until the future event is within a specified time distance, to wit, within a specified time period, from a current time.

The manner of cognitive incident analysis and predictive notification described herein is unavailable in the presently available methods. A method of an embodiment described herein, when implemented to execute on a device or data processing system, comprises substantial advancement of the functionality of that device or data processing system in alerting users about incidents likely to occur in future based on user's current and past activities, and to cause or advise about possible corrective actions to avoid those incidents.

The illustrative embodiments are described with respect to certain types of data items, datasets, incidents, anomalies, data characteristics, root causes, incident insight logic, normalization, predictions, confidence ratings, adjustments, preferences, notifications, corrective actions, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

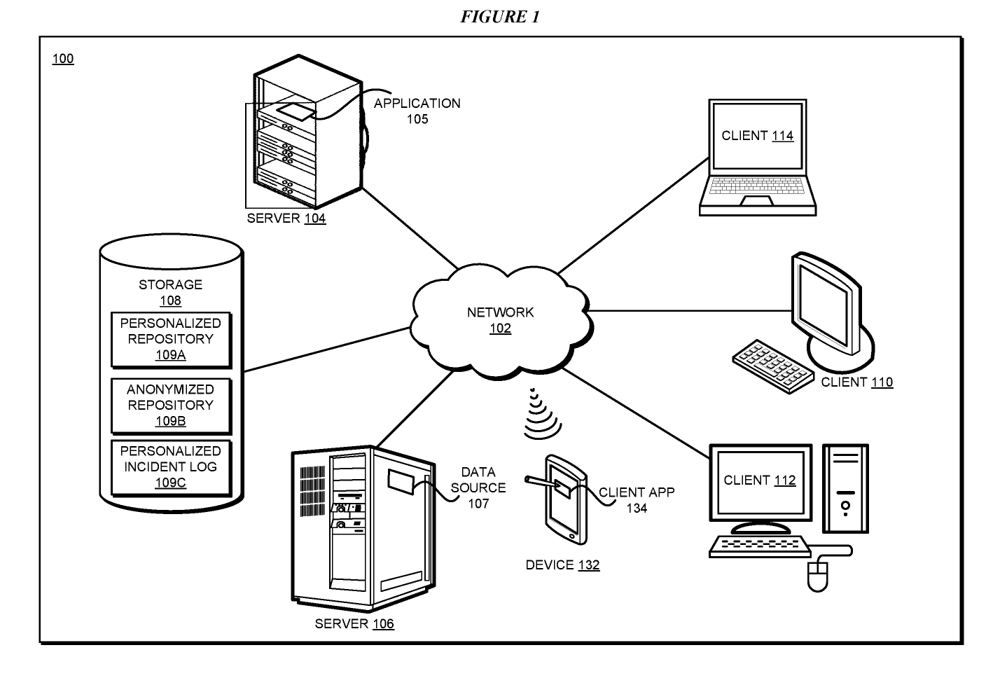

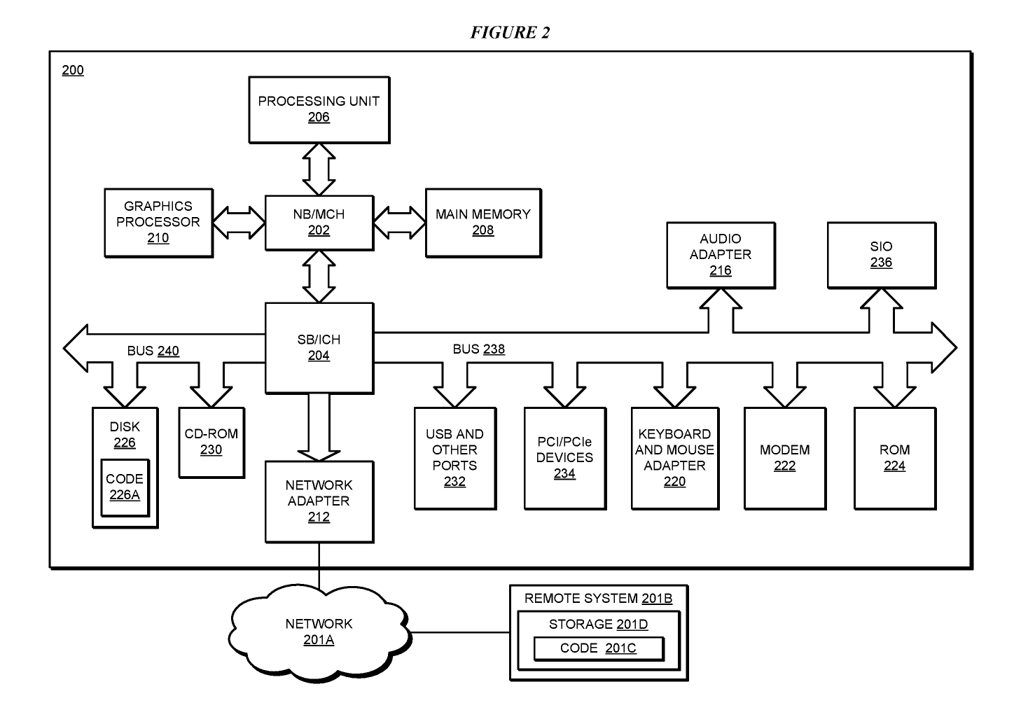

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 implements an embodiment described herein. Client app 134 executing on device 132 associated with a user is configured to provide one or more data items in a dataset to application 105 as described herein. Data source 107 may execute in a cloud infrastructure or other data processing environment, and provide one or more data items in a dataset to application 105 as described herein. Application 105 constructs and maintains personalized repository 109A of personalized incident insight logic. Application 105 constructs and maintains personalized repository 109B of anonymized incident insight logic. Application 105 constructs and maintains personalized incident log repository 109C of incident log entries related to the user of device 132.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

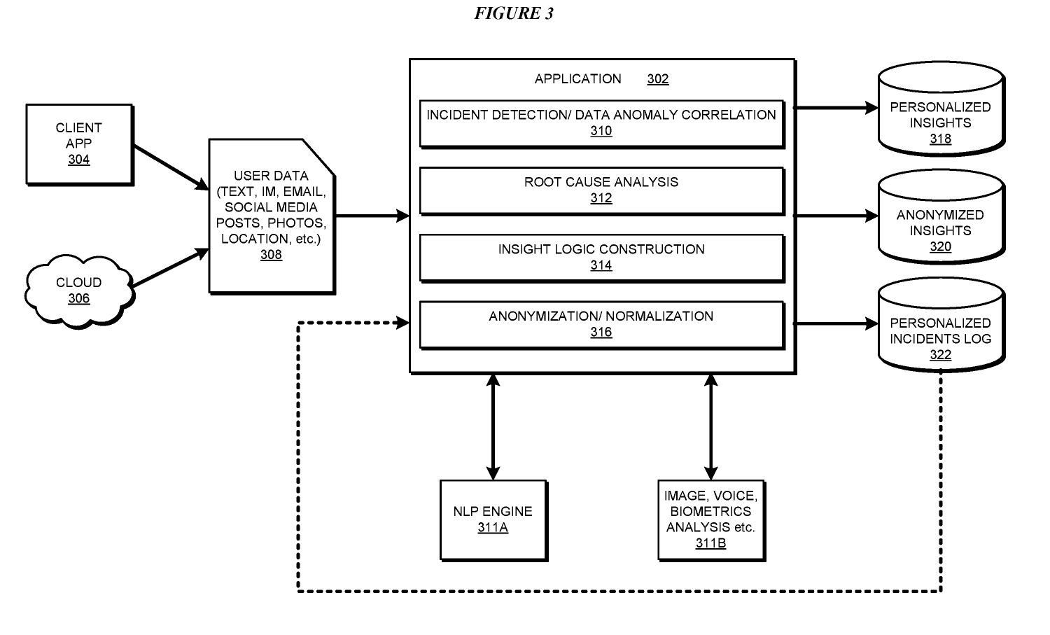

With reference to FIG. 3, this figure depicts a block diagram of an example configuration for cognitive incident analysis and predictive notification in accordance with an illustrative embodiment. Application 302 is an example of application 105 in FIG. 1. Client app 304 is an example of client app 134 in FIG. 1. Cloud 306 Includes a data source, such as data source 107 in FIG. 1.

Client app 304 and/or cloud 306 provide dataset 308 as input to application 302. Dataset 308 includes user data items, such as including but not limited to text messages, instant messages, social media posts, email messages, photographs, voice recordings, biometric data, location data, and so on. Dataset 308 pertains to an event that has already occurred at a past time.

Component 310 performs incident detection in dataset 308, such as by detecting data anomalies and correlations between the anomalies, as described herein. As some non-limiting examples, component 310 may use external functions 311A and 311B to perform the detection. External function 311A may be, for example, an NLP engine for performing NLP on textual data. External function 311B may be, for example, an image analysis capability, voice analysis capability, biometrics analysis capability, or some combination of these and other functions as may be needed in an implementation.

Component 312 performs root cause analysis on the incident that is detected in dataset 308. For example, component 312 determines the data characteristics in the data items of dataset 308, correlations between the data characteristics, and correlations between the anomalies and the characteristics, as described herein. Component 314 constructs one or more incident insight logic from the determined anomalies, data characteristics, and correlations. Component 316 normalizes or anonymizes the constructed incident insight logic.

Application 302 outputs the incident insight logic constructed in component 314 to repository 318, which is an example of repository 109A in FIG. 1. Application 302 outputs the incident insight logic anonymized in component 316 to repository 320, which is an example of repository 109B in FIG. 1. Application 302 outputs the anomalies, data characteristics, data items, root cause, and other items as described herein, in the form of one or more personalized incident log entries in repository 322, which is an example of repository 109C in FIG. 1.

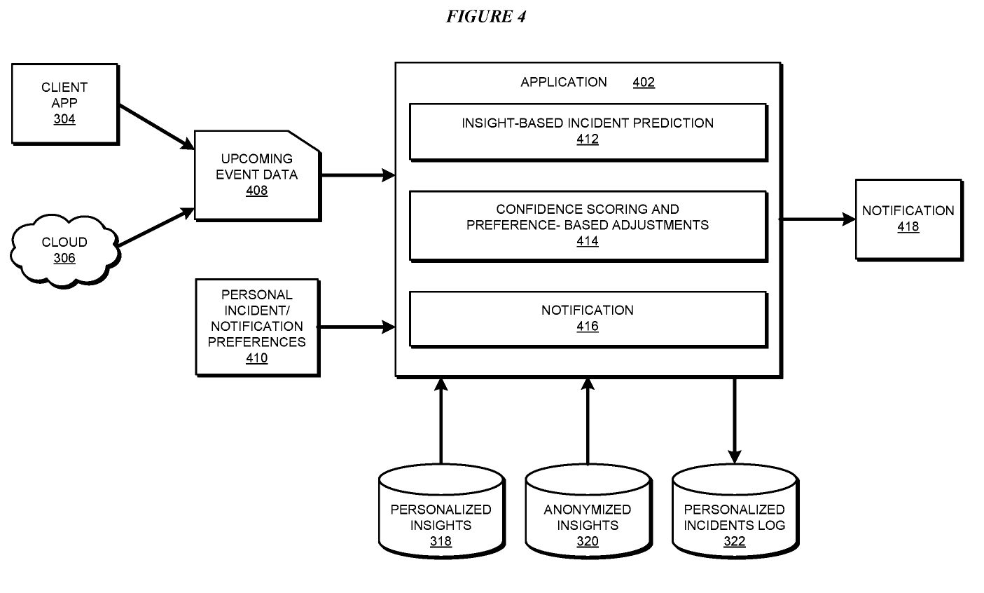

With reference to FIG. 4, this figure depicts a block diagram of another configuration for cognitive incident analysis and predictive notification in accordance with an illustrative embodiment. Application 402 is an example of application 105 in FIG. 1 and can be implemented as an extension of application 302 wherein the resulting application has the features described with respect to applications 302 and 402. Alternatively, the features of application 302 and application 402 can be implemented as two separate applications, e.g., as two separate instances of application 105 in FIG. 1, each with the corresponding set of features as described herein.

Client app 304 and/or cloud 306 are the same artifacts as in FIG. 3. Client app 304 and/or cloud 306 provide dataset 408 as input to application 402. Dataset 408 is similar to dataset 308 in FIG. 3, except that dataset 408 pertains to an event that will occur at a future time. Preferences 410 include one or more preferences configured by a user where those preferences are usable to adjust a confidence value of an incident prediction in a manner described herein.

Component 412 uses an incident insight logic, e.g., from repository 318 or 320, to predict whether an incident is likely to occur in the future given dataset 408. Data of the likely incident is logged in personalized incident log repository 322 as a new personalized incident log entry.

For an event that is likely to occur, component 414 computes a confidence value as described herein. Component 414 adjusts the computed confidence value using a preference from preferences 410 in a manner described herein.

When the original or adjusted confidence value justifies notification in a manner described herein, component 416 constructs and sends notification 418 to a device associated with the user, such as to client app 304. Optionally (not shown), component 416 may automatically actuate a corrective action described in notification 418.

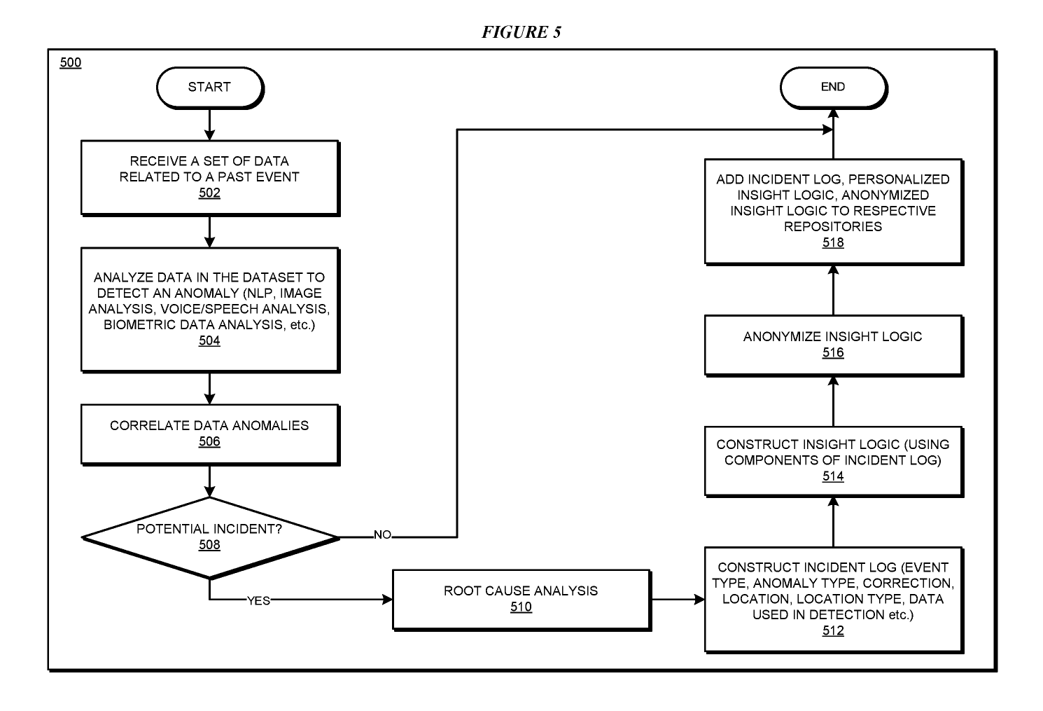

With reference to FIG. 5, this figure depicts a flowchart of an example process for cognitive incident analysis and predictive notification in accordance with an illustrative embodiment. Process 500 can be implemented in application 302 in FIG. 3.

The application receives a dataset related to a past event (block 502). The application analyzes the data items in the data set to detect an anomaly, e.g., by using NLP or other analysis on the data items (block 504).

The application correlates the detected anomalies with one another (block 506). The application determines whether the correlated anomalies are indicative of an incident (block 508). If the correlated anomalies are not indicative of an incident (“No” path of block 508), the application ends process 500 thereafter. If the correlated anomalies are indicative of an incident (“Yes” path of block 508), the application performs a root cause analysis, e.g. by identifying a set of data characteristics that lead to an action or an inaction that caused the incident (block 510).

The application constructs an incident log entry (block 512). The application constructs an incident insight logic (block 514). The application anonymizes the incident insight logic (block 516). The application adds the incident log, the incident insight logic, and the anonymized incident insight logic to their respective repositories (block 518). The application ends process 500 thereafter.

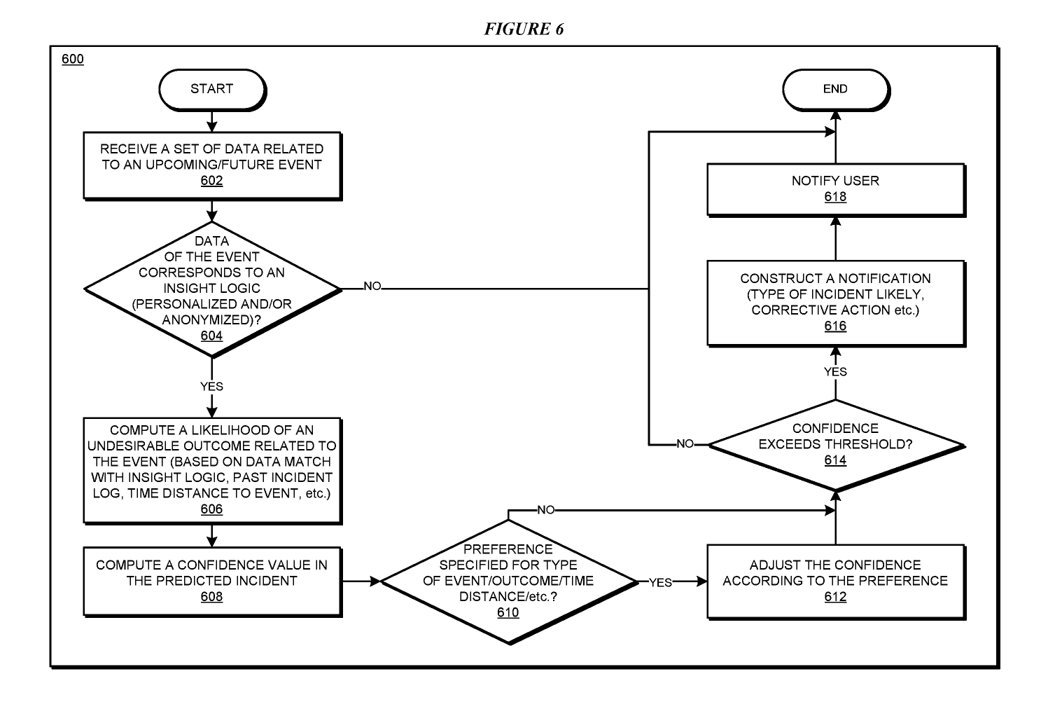

With reference to FIG. 6, this figure depicts a flowchart of another example process for cognitive incident analysis and predictive notification in accordance with an illustrative embodiment. Process 600 can be implemented in application 302 in FIG. 3.

The application receives a dataset related to an upcoming or future event (block 602). The application determines whether the data characteristics in the dataset match to a threshold degree with an incident insight logic, e.g., with the root cause characteristics in a personalized or anonymized incident insight logic (block 604). If the data characteristics in the dataset do not match to e threshold degree with an incident insight logic (“No” path of block 604), the application ends process 600 thereafter.

If the data characteristics in the dataset match to the threshold degree with an incident insight logic (“Yes” path of block 604), the application computes a likelihood of an incident occurring at a future time related to the event (block 606). The application computes a confidence value corresponding to the prediction of the future incident (block 608). The application determines whether a preference has been specified by the user for the future event, type of predicted incident, a period within which the incident should occur for notification, and so on as described herein (block 610).

If a preference has been specified (“Yes” path of block 610), the application adjusts the confidence value according to the preference (block 612). The application then proceeds to block 614. If a preference has not been specified (“No” path of block 610), the application proceeds to block 614.

The application determines whether the original confidence value or the adjusted confidence value, as the case may be, exceeds a notification threshold (block 614). If the confidence value does not exceed the notification threshold (“No” path of block 614), the application ends process 600 thereafter.

If the confidence value does exceed the notification threshold (“Yes” path of block 614), the application constructs a notification message as described herein (block 616). The application notifies the user (block 618). Optionally (not shown), the application causes a corrective action specified in the notification to be actuated at block 618 as well. The application ends process 600 thereafter.

Thus, a computer implemented method, system or apparatus, and computer program product are provided in the illustrative embodiments for cognitive incident analysis and predictive notification and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
analyzing, using a processor and a memory, a data item in a dataset related to a past event, to identify an anomaly in the data item;
determining a set of data characteristics in the dataset, the set of data characteristics forming a root cause of an undesirable outcome related to the past event;
constructing an incident insight logic using the set of data characteristics;
evaluating, using the processor and the memory, that a second dataset related to a future event satisfies the incident insight logic;
computing, responsive to the evaluating, a confidence value of a predicted undesirable outcome related to the future event; and
selecting a corrective action that has been configured to avoid an occurrence of the predicted undesirable outcome.

2. The method of claim 1, further comprising:
automatically performing the corrective action.

3. The method of claim 1, further comprising:
sending a notification, the notification including the corrective action.

4. The method of claim 1, further comprising:
obtaining a preference specified by the user, wherein the preference is specified for a period within which the future event is predicted to occur; and
adjusting the confidence value according to the preference.

5. The method of claim 1, further comprising:
obtaining a preference specified by the user, wherein the preference is specified for a circumstance of the predicted undesirable outcome; and
adjusting the confidence value according to the preference.

6. The method of claim 1, further comprising:
obtaining a preference specified by the user, wherein the preference is specified for the future event; and
adjusting the confidence value according to the preference.

7. The method of claim 1, further comprising:
determining that the predicted undesirable outcome is likely relative to the future event, wherein the confidence value is indicative of a degree to which the second dataset related to the future event satisfies the incident insight logic.

8. The method of claim 1, further comprising:
determining, as a part of the evaluating, that at least a subset of the second dataset matches within a tolerance value with a corresponding subset of data characteristics in the root cause of the incident insight logic.

9. The method of claim 1, further comprising:
determining, as a part of the evaluating, that at least a threshold sized subset of the second dataset matches with a corresponding subset of data characteristics in the root cause of the incident insight logic.

10. The method of claim 1, wherein data characteristics in a subset of data characteristics are correlated with one another to lead to a different data characteristic in the dataset, wherein the different data characteristic is indicative of one of an action and an inaction resulting in the undesirable outcome related to the past event.

11. The method of claim 1, further comprising:
performing, as a part of the analyzing, biometric data processing on a graphical content in the data item, wherein the anomaly comprises a biometric expression of the undesirable outcome related to the past event.

12. The method of claim 1, further comprising:
performing, as a part of the analyzing, audio processing on an audio content in the data item, wherein the anomaly comprises an audible expression of the undesirable outcome related to the past event.

13. The method of claim 1, further comprising:
performing, as a part of the analyzing, image processing on a graphical content in the data item, wherein the anomaly comprises a graphical expression of the undesirable outcome related to the past event.

14. The method of claim 1, further comprising:
performing, as a part of the analyzing, natural language processing (NLP) on a textual content in the data item, wherein the anomaly comprises a textual expression of the undesirable outcome related to the past event.

15. A computer usable program product comprising one or more computer-readable storage devices, and program instructions stored on at least one of the one or more storage devices, the stored program instructions comprising:
program instructions to analyze, using a processor and a memory, a data item in a dataset related to a past event, to identify an anomaly in the data item;
program instructions to determine a set of data characteristics in the dataset, the set of data characteristics forming a root cause of an undesirable outcome related to the past event;
program instructions to construct an incident insight logic using the set of data characteristics;
program instructions to evaluate, using the processor and the memory, that a second dataset related to a future event satisfies the incident insight logic;
program instructions to compute, responsive to the evaluating, a confidence value of a predicted undesirable outcome related to the future event; and
program instructions to select a corrective action that has been configured to avoid an occurrence of the predicted undesirable outcome.

16. The computer usable program product of claim 15, further comprising:
program instructions to automatically perform the corrective action.

17. The computer usable program product of claim 15, further comprising:
program instructions to send a notification, the notification including the corrective action.

18. The computer usable program product of claim 15, wherein the computer usable code is stored in a computer readable storage device in a data processing system, and wherein the computer usable code is transferred over a network from a remote data processing system.

19. The computer usable program product of claim 15, wherein the computer usable code is stored in a computer readable storage device in a server data processing system, and wherein the computer usable code is downloaded over a network to a remote data processing system for use in a computer readable storage device associated with the remote data processing system.

20. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to analyze a data item in a dataset related to a past event, to identify an anomaly in the data item;
program instructions to determine a set of data characteristics in the dataset, the set of data characteristics forming a root cause of an undesirable outcome related to the past event;
program instructions to construct an incident insight logic using the set of data characteristics;
program instructions to evaluate that a second dataset related to a future event satisfies the incident insight logic;
program instructions to compute, responsive to the evaluating, a confidence value of a predicted undesirable outcome related to the future event; and
program instructions to select a corrective action that has been configured to avoid an occurrence of the predicted undesirable outcome.
